(19) United States
(12) Patent Application Publication
(10) Pub. No.: US 2018/0160334 A1
(43) Pub. Date: Jun. 7, 2018

(54) TECHNIQUES FOR MANAGING WLAN AP-CLIENT MAPPING IN A MULTI-RADIO SYSTEMS

(71) Applicant: QUALCOMM Incorporated, San Diego, CA (US)

(72) Inventor: Pankaj DESHPANDE, San Diego, CA (US)

(21) Appl. No.: 15/370,847

(22) Filed: Dec. 6, 2016

(51) Int. Cl. H04W 28/08; H04W 4/00; H04W 84/12

(52) U.S. Cl. CPC H04W 28/08; H04W 88/08; H04W 84/12; H04W 4/008

(57) ABSTRACT

Techniques are provided for offloading a wireless local area network (WLAN) scanning process, from the WLAN radio of the device to a Bluetooth radio, to identify information regarding the WLAN mobile environment. By offloading the WLAN scanning process to the Bluetooth radio (e.g., to a Bluetooth Low Energy (BLE) radio), traffic disruptions for active WLAN links is reduced. The techniques further provide for the creation of an ad-hoc network using the Bluetooth interface between multiple STAs and one or more access points (APs), each exchanging information regarding the WLAN environment over the respective Bluetooth radios. The ad-hoc Bluetooth network allows each device on the network to be more aware of the mobile environment. The increased aware may allow the leader AP to optimize AP-Client mapping table that maps the one or more STAs in the ad-hoc network to the one or more APs for improved load balancing.

### BACKGROUND OF THE DISCLOSURE

Aspects of this disclosure relate generally to telecommunications, and more particularly to managing wireless local area networks (WLAN) scanning in a multi-radio systems.

The deployment of WLANs in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. In some examples, a set of STAs can communicate with each other through a common AP in what is referred to as a basic service set (BSS).

Some WLAN network deployments may be dense (e.g., have a large number of STAs deployed within the coverage area of multiple APs), which may result in issues related to load balancing on each AP and channel or medium usage. Traditional approaches to solving load balancing have focused on multi band operation (MBO) and optimized connection experience (OCE) services. Each of these approaches, however, generally relies on frequent scanning by the WLAN radio of a device in order to make informed roaming, steering, and load balancing decisions. However, such traditional WLAN scanning processes reduce performance of the device (e.g., STA or AP) on the active links by interrupting active WLAN traffic on a channel to send probes and receive probe responses. Additionally, periodic scans by the WLAN radio may adversely impact the power performance of the device because WLAN radio scanning processes are power intensive operations that may keep the WLAN radio occupied in receiver (Rx) and transmitter (Tx) modes for a duration of at least 30 milliseconds during each instance.

### SUMMARY

Implementations of the present disclosure provide techniques for offloading the WLAN scanning process, from the WLAN radio of a multi-radio device (e.g., STA or AP) to a Bluetooth radio of the same multi-radio device (e.g., a Bluetooth Low Energy (BLE) radio), to identify information regarding the WLAN mobile environment. By offloading the WLAN scanning process to the BLE radio, features of the present disclosure may reduce the active traffic disruptions on the WLAN radio that generally accompany traditional WLAN radio scanning operations. In some examples, the term “BLE radio” may refer to a Bluetooth radio that provides reduced power consumption and cost while maintaining similar communication range of a standard Bluetooth radio. For example, a device may concurrently communicate WLAN traffic using the WLAN radio, while performing periodic scanning for WLAN mobile environment using the BLE radio.

Additionally or alternatively, features of the present disclosure provide techniques for creating an ad-hoc network using the Bluetooth interface between multiple STAs and one or more APs (collectively “devices”) such that each device (e.g., AP and STA) each exchange information regarding the WLAN environment over their respective BLE radios. By creating an ad-hoc Bluetooth network, each device may be more aware of the WLAN mobile environment (e.g., by generating a spatial map of all the devices in the network and their relative position and orientation with respect to each other). An improved WLAN mobile environment awareness may allow a leader AP from the one or more APs in the ad-hoc network to create an optimal AP-Client mapping information that maps the STAs in the ad-hoc network to the one or more APs in the network for improved load balancing. The term “leader AP” may refer to a single AP selected from a plurality of APs in the ad-hoc network that collects information over Bluetooth interface from one or more other APs in the region, as well as the one or more STAs connected to the plurality of APs. As such, the leader AP may receive, from another AP in the network, information about one or more STAs associated with that other AP. The term “AP-Client mapping information” may refer to the relationship between an AP and STA that identifies which STAs should ideally connect to which AP (e.g., based on the proximity of the STA to the AP). Optimal AP-Client mapping may be achieved by distributing the plurality of STAs in the ad-hoc network substantially evenly across a plurality of APs such that no one AP is servicing significantly higher number of STAs than another AP. As such, the traffic load may be distributed more evenly that maximizes the utilization of existing resources (e.g., deployed APs) and increases STA throughput because the wireless channels between each AP and STA may not be as crowded as in systems with poor load distribution.

In one example, a method for wireless communication is disclosed. The method may include offloading, at a wireless STA, a scanning process to identify information regarding a WLAN mobile environment from a WLAN radio to a Bluetooth radio. The method may further include collecting the information regarding the WLAN mobile environment based on the offloading, and transmitting the information from the STA to a leader AP using the Bluetooth radio. In some examples, the leader AP may be one of one or more APs in a network. The method may further include receiving, from the leader AP, a mapping information that maps the STA to the one or more APs in the network.

In another example, an apparatus for wireless communication is disclosed. The apparatus may include a processor and a memory coupled to the processor. The memory may include instructions executable by the processor to offload, at a wireless STA, a scanning process to identify information regarding a WLAN mobile environment from a WLAN radio to a Bluetooth radio. The instructions may further be executable to collect the information regarding the WLAN mobile environment based on the offloading, and transmitting the information from the STA to a leader AP using the Bluetooth radio. In some examples, the leader AP may be one of one or more APs in a network. The instructions may further be executable to receive, from the leader AP, a mapping information that maps the STA to the one or more APs in the network.

In yet another example, a computer-readable medium storing computer executable code for wireless communications. The computer-readable medium may include code to offload, at a wireless STA, a scanning process to identify information regarding a WLAN mobile environment from a WLAN radio to a Bluetooth radio. The code may further collect the information regarding the WLAN mobile environment based on the offloading, and transmitting the information from the STA to a leader AP using the Bluetooth radio. In some examples, the leader AP may be one of one or more APs in a network. The code may further receive, from the leader AP, a mapping information that maps the STA to the one or more APs in the network.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a conceptual diagram illustrating an example of a wireless local area network (WLAN) deployment;

FIG. 2 is a diagram that illustrates a spatial map, where information representative of such a map is generated by a leader AP of the ad-hoc mesh network in order to aid the leader AP 105-a in balancing the network load across a plurality of APs.

FIG. 3 is a schematic diagram of a STA that may implement various aspects of the present disclosure;

FIG. 4 illustrates one example of a flowchart, implemented by a STA, that shows aspects for offloading the WLAN scanning to Bluetooth radio in accordance with various aspects of the present disclosure;

FIG. 5 is a schematic diagram of an AP that may implement various aspects of the present disclosure; and

FIG. 6 illustrates one example of a flowchart, implemented by an AP, that shows aspects for generating a mapping information based on the spatial map for load balancing in accordance with various aspects of the present disclosure.

### DETAILED DESCRIPTION

As discussed above, traditional WLAN scanning processes reduce performance of the device (e.g., STA or AP) on the active links by interrupting active WLAN traffic on a channel (e.g., stopping WLAN radio) to send probes and receive probe responses. If there are multiple devices in high density environments, scanning by the multiple devices may include the transmission of Request-to-Send/Clear-to-Send (RTS/CTS) signals to mediate access to the shared medium. The transmissions of RTS/CTS signals may result in the WLAN bandwidth being substantially occupied for the purposes of scanning, while barring devices from transmitting packets during this period. Thus, traditional approaches result in inefficient use of the available bandwidth. Additionally, periodic scans by the WLAN radio may also adversely impact the power performance of the device due to WLAN radio scanning processes being power intensive operations.

Features of the present disclosure solve the above-identified problem by offloading the WLAN scanning from a first radio access technology (RAT) radio to a second RAT radio within the same multi-radio device. For example, WLAN scanning may be offloaded from a WLAN radio to a BLE radio. That is, multi-radio devices that have both WLAN and BLE radios may offload, from the WLAN radio to the BLE radio, the scanning process to identify and collect information regarding the WLAN mobile environment (e.g., identifying other APs in the vicinity of the one or more STAs that may provide better signal quality). In some examples, the term “WLAN mobile environment” may refer to identification of devices (e.g., APs and other STAs) that may be in vicinity of the device performing the scanning. For example, a device performing the scanning using the BLE radio may receive or detect WLAN signals transmitted by WLAN APs in range of said device, and extract information from said received (or detected) WLAN signals to identify the WLAN APs. Particularly, because BLE radio may be configured to operate on similar frequency bandwidth as the WLAN radio, the BLE radio may detect the WLAN signals to identify any nearby APs that may be in range of the scanning device and estimate the position of the device itself in relation to the AP (e.g., based on RTT). In some examples, the BLE radio may scan only a pre-determined and selected subset of WLAN channels to identify WLAN APs in range of the device.

The transition from the WLAN radio to BLE radio for the scanning process may also allow multiple STAs and APs in the vicinity of one another (e.g., physical coverage area) to form an ad-hoc network (e.g., mesh network) to exchange mobile environment information over Bluetooth interface (e.g., via BLE radio) without disrupting the WLAN traffic on the WLAN radio. The terms “ad-hoc network” or “mesh network” may be used interchangeably to describe a network made up of devices (e.g., radio nodes) organized in a mesh topology in which each device relays data for the network. Thus, in an “ad-hoc network” or “mesh network”, the one or more devices of the ad-hoc network cooperate in the distribution of data in the network.

In further implementations, a single AP from a plurality of APs in the ad-hoc network may be designated as a “leader AP” that collects information over Bluetooth interface from one or more other APs in the region, as well as the one or more STAs connected to the plurality of APs. Stated differently, the leader AP may coordinate information exchange with not only other APs, but may also receive information from STAs connected to both the leader AP itself and the plurality of other APs that may be in the network. As such, the leader AP may receive, from another AP in the network, information about one or more STAs associated with that other AP.

For example, the one or more APs in the ad-hoc network may transmit information related to the WLAN mobile environment to the leader AP via the Bluetooth interface. The information from the one or more APs may include identification of the one or more STAs that may be connected to each AP, the relative position of each AP in the network, relative distance between an AP and another nearby AP (calculated using round-trip time (RTT)), relative distance of the one or more APs from the leader AP, and the AP capabilities (e.g., multi-user multiple-input and multiple output (MU-MIMO) support or transmit beam forming support, etc.). Similarly, each of the STAs in the ad-hoc network may send their respective distance from the leader AP, distance from a serving AP that the STA is currently connected to, the channel quality information between the STA and the serving AP, the channel number being used by the STA, and/or the capabilities of the STA (e.g., MU-MIMO support, transmit beam forming support, etc.). For STAs not within the coverage area of the leader AP, the information regarding the WLAN mobile environment information may be relayed over the mesh network (e.g., in peer-to-peer network) from one STA to the next. Specifically, in such situation, the WLAN mobile environment information may be transmitted from a first STA to a second STA via a Bluetooth interface such that the second STA may send the received information to its associated AP (also via Bluetooth interface). The associated AP may, in turn, forward the information to the leader AP. As such, information collected from STAs outside the communication range of the leader AP may nonetheless be forwarded to the leader AP to allow the leader AP to identify optimal AP-Client mapping.

Based on the improved network awareness (by receiving the information related to WLAN mobile environment from the plurality of APs and STAs), the leader AP may generate a spatial map of all the devices (e.g., STAs and APs) in the network and the relative position and orientation of each device with respect to each other. The generated spatial map may aid the leader AP in preparing a mapping information (e.g., AP-Client mapping table that correlates multiple STAs to respective APs) that maps the one or more STAs in the ad-hoc network (e.g., mesh network) to the one or more APs in the network in order to optimize the load balancing across the plurality of APs. In some examples, the leader AP may transmit the mapping information as a guidance to the one or more STAs in order to allow each STA to individually select a target AP from a set of available target APs identified in the mapping information. The term “target AP” may refer to an AP that is not currently serving the STA, but to which the STA may transition to if the target AP provides better signal quality than the serving AP. Based on the mapping information, the one or more STAs may establish communication with target APs from the one or more APs. It should be noted that while the WLAN mobile environment information and the mapping information may be exchanged using the Bluetooth interface of the BLE radio, the one or more STAs may establish communication with the target AP using the WLAN radio to communicate WLAN traffic.

Because the information related to WLAN mobile environment and the mapping information is exchanged between the plurality of APs and STAs over a Bluetooth interface using BLE radios, features of the present disclosure avoid disruptions to WLAN traffic on the WLAN radio. Thus, in some examples, the techniques described herein leverage the complementary and co-existence features of the Bluetooth and WLAN (e.g., Bluetooth radio may monitor the same frequency band (e.g., 2.5 GHz) used by the WLAN radio) to maximize available bandwidth utilization, while minimizing the interferences that may otherwise exist between two radios operating on the same device. This is because both technologies (e.g., Bluetooth and WLAN) have their preferred area of usage, and these areas are complementary rather than competitive. Thus, the techniques described herein achieve improved STA distribution and roaming across various APs while achieving minimal disruption to the active WLAN traffic.

Various concepts will now be described more fully hereinafter with reference to the accompanying drawings. These concepts may, however, be embodied in many different forms by those skilled in the art and should not be construed as limited to any specific structure or function presented herein. Rather, these concepts are provided so that this disclosure will be thorough and complete, and will fully convey the scope of these concepts to those skilled in the art. The detailed description may include specific details. However, it will be apparent to those skilled in the art that these concepts may be practiced without these specific details. In some instances, well known structures and components are shown in block diagram form in order to avoid obscuring the various concepts presented throughout this disclosure.

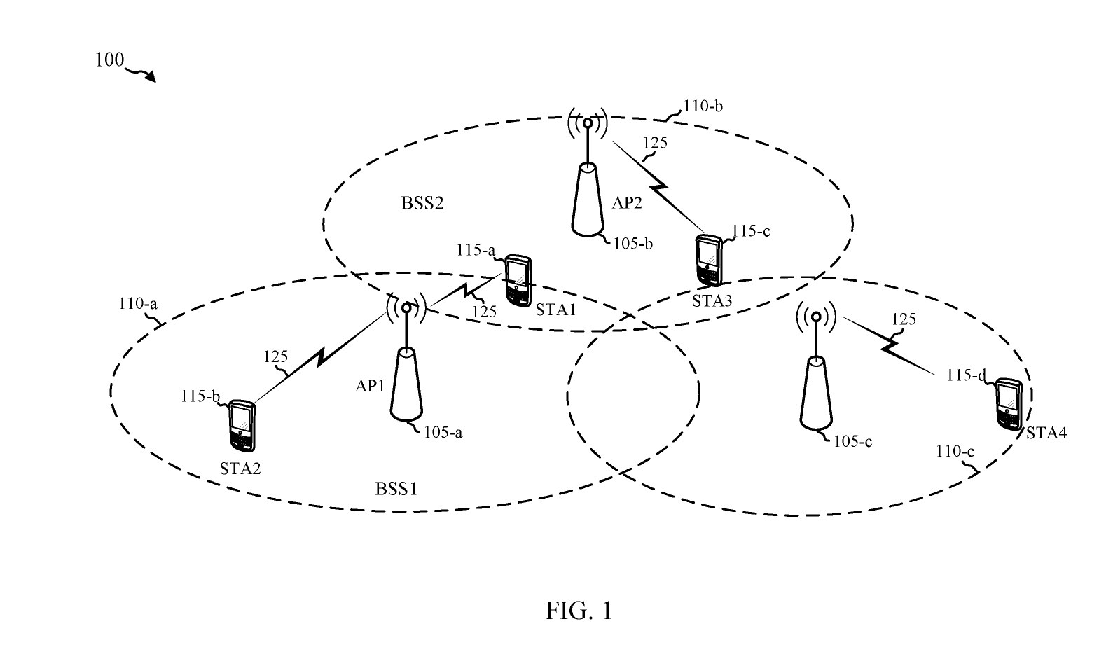

FIG. 1 is a conceptual diagram 100 illustrating an example of a wireless local area network (WLAN) deployment in connection with various techniques described herein. The WLAN may include one or more access points (APs) and one or more mobile stations (STAs) associated with a respective AP. In this example, there are three APs deployed: AP1 105-a in basic service set 1 (BSS1), AP2 105-b in BSS2, and AP3 105-c in BSS3. AP1 105-a is shown as having at least two associated STAs (STA1 115-a and STA2 115-b) and coverage area 110-a, while AP2 105-b is shown having at least one associated STAs (STA3 115ca) and coverage area 110-b. AP3 105-c is also shown having at least one associated STAs (e.g., STA4 105-d) in the coverage area 110-c. The STAs and AP associated with a particular BSS may be referred to as members of that BSS. In the example of FIG. 1, the coverage area 110-a of AP1 105-a may overlap part of the coverage area 110-b of AP2 105-b such that STA1 115-a may be within the overlapping portion of the coverage areas. Similarly, the coverage area 110-b of AP2 105-b and the coverage area 110-c of AP3 105-c may overlap such that the STA3 115-c may be within the overlapping portion of the coverage areas. The number of BSSs, APs, and STAs, and the coverage areas of the APs described in connection with the WLAN deployment of FIG. 1 are provided by way of illustration and not of limitation.

In some examples, the APs (e.g., AP1 105-a, AP2 105-b, and AP3 105-c) shown in FIG. 1 are generally fixed terminals that provide backhaul services to STAs 115 within its coverage area or region. In some applications, however, the AP may be a mobile or non-fixed terminal. The STAs (e.g., STA1 115-a, STA2 115-b, STA3 115-c, and STA4 115-d) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, or any other suitable terminology. The various concepts described throughout this disclosure are intended to apply to all suitable wireless apparatus regardless of their specific nomenclature.

Each of STA1 115-a, STA2 115-b, STA3 115-c, and STA4 115-d may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a, AP2 105-b, and AP3 105-c can include software applications and/or circuitry to enable associated STAs to connect to a network via communications link 125. The APs can send frames or packets to their respective STAs and receive frames or packets from their respective STAs to communicate data and/or control information (e.g., signaling). Each of AP1 105-a, AP2 105-b, and AP3 105-c can establish a communications link 125 with an STA that is within the coverage area of the AP. Communications link 125 can comprise communications channels that can enable both uplink and downlink communications. When connecting to an AP, a STA can first authenticate itself with the AP and then associate itself with the AP. Once associated, a communications link 125 may be established between the AP 105 and the STA 115 such that the AP 105 and the associated STA 115 may exchange frames or messages through a direct communications channel. It should be noted that the wireless communication system, in some examples, may not have a central AP (e.g., AP 105), but rather may function as a peer-to-peer network between the STAs. Accordingly, the functions of the AP 105 described herein may alternatively be performed by one or more of the STAs 115.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for performing operations based on modifications and enhancements to dynamic sensitivity control may be applicable to any suitable wireless network regardless of the coverage range and the wireless access protocols utilized.

In some examples, the one or more APs 105 and STAs 115 may be configured with multi-radio systems (e.g., WLAN radio and BLE radio) to support concurrent communications on each radio. Thus, features of the present disclosure offload the WLAN scanning from a first RAT radio (e.g., WLAN radio) to a second RAT radio (e.g., BLE radio) within the same multi-radio device. For example, WLAN scanning may be offloaded from a WLAN radio to a BLE radio. In some examples, a Wi-Fi radio may be an example of a WLAN radio. Additionally, the WLAN radio (or Wi-Fi radio) may support multiple IEEE 802.11 standards, including IEEE 802.11ax and legacy standards.

The devices (e.g., APs 105 and STAs 115) may create an ad-hoc network (e.g., mesh network) using the Bluetooth interface (via BLE radio) to exchange information regarding the WLAN mobile environment. The term “Bluetooth interface” may refer to protocol for communicating signals between two devices using Bluetooth. Thus, the ad-hoc network (e.g., mesh network) may be a Bluetooth mesh network where each device in the network exchanges WLAN mobile environment information using BLE radio. Further, the devices (e.g., APs 105 and STAs 115) may select a leader AP (e.g., AP 105-a) that may coordinate receiving information from the one or more APs 105 and STAs 115 to prepare a mapping information that maps the one or more STAs 115 with respective APs 105 to achieve ideal load balancing. The mapping information may be generated based on a spatial map that identifies the relative position and orientation of each device in the ad-hoc network.

In accordance with features of the present disclosure, there may be only one leader AP 105-a that may be selected in the mesh network from a set of available APs 105. However, if the leader AP 105-a is disabled or ceases to perform the one or more functions assigned to the leader AP 105-a, another AP 105 may be dynamically selected to replace the leader AP 105-a. In some examples, the leader AP 105-a may be selected when an AP 105 that is not currently a member of any existing mesh network advertises (e.g., transmits a broadcast message) intentions to create a mesh network with a mesh identification (ID). If there is no existing mesh in the vicinity of the AP 105 advertising the creation of the mesh network, the originating AP 105 may be identified as the “leader AP” of the network for all subsequent devices that may connect to the mesh network. However, if there is already an existing mesh in the vicinity of the AP 105 that transmitted the mesh creation advertisement, the leader AP 105-a of that mesh may challenge creation of a new mesh network. Instead, the leader AP 105-a of the existing mesh network may request that the AP 105 that intends to initiate a new mesh network join the existing mesh network established by the leader AP 105-a. In some aspects, the leader AP 105-a may be the longest active AP 105 in the network (e.g., based on time duration). This ensures that a more stable and dependent AP 105 is selected as the leader AP 105-a from a plurality of APs in the network. In order to identify the active state of the leader AP 105-a, the leader AP 105-a may periodically transmit a heartbeat (e.g., “pulses” or “beacons”) to all the devices in the network to confirm that the leader AP 105-a is active.

Further, in order to ensure that only one AP 105 in the mesh network is selected as a leader AP 105-a, the leader AP 105-a may be configured to listen for advertisements for mesh creations from other APs 105 in order to issue challenges that prevent formation of the new mesh network when an existing mesh network exists. In a challenge scenario, the leader AP 105-a that had created a mesh network at an earlier time may win and remain the leader AP 105-a. In such situation, the new AP 105-a that intended to create a new mesh network may join the existing mesh network based on determination of the challenge.

In some examples, the leader AP 105-a may be configured to receive information from the one or more APs 105 (e.g., AP 105-b) in addition to one or more STAs 115 (e.g., STA1 115-a, STA 2 115-b, and STA3 115-c) irrespective of the AP (AP 105-a or AP 105-b) to which the STA 115 is connected. Based on the collected information regarding the WLAN mobile environment that is periodically collected and forwarded by each device executing the scanning process, the leader AP 105-a may generate a spatial map of all the devices (e.g., AP 105 and STA 115) in the network and the relative position and orientation of each device with respect to each other. Using this information, the leader AP 105 can identify which STAs 115 are in proximity of which AP 105 to achieve maximum bandwidth utilization. In doing so, the leader AP 105-a may also consider the capabilities of the APs 105 and STAs 115 (e.g., MU-MIMO capabilities) that may identify the ideal pairing of STAs 115 to the one or more target APs 105.

In some aspects, one or more APs (105-a and 105-b) may transmit on one or more channels (e.g., multiple narrowband channels, each channel including a frequency bandwidth) a beacon signal (or simply a “beacon”), via a communications link 125 to STA(s) 115 of the wireless communication system, which may help the STA(s) 115 to synchronize their timing with the APs 105, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

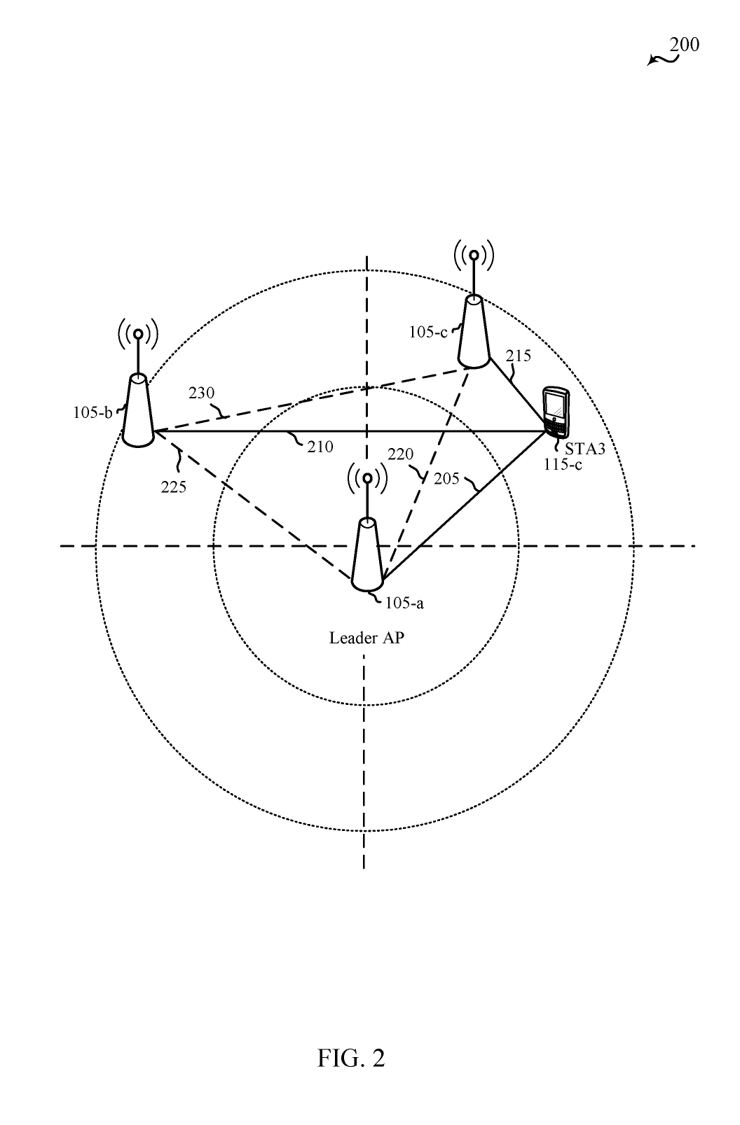

FIG. 2 is a diagram that illustrates a spatial map 200, where information representative of such a map is generated by a leader AP 105-a of the ad-hoc mesh network in order to aid the leader AP 105-a in balancing the network load across a plurality of APs. In some examples, the leader AP 105-a may be aware of or receive standard AP location information that identifies physical location of the one or more APs 105 (e.g., AP 105-b and 105-c) in relation to the leader AP 105-a. The standard AP location information supplemented with round trip time (RTT) based distance information that the leader AP 105-a may receive from one or more APs 105 and/or STAs 115 in the network may allow the leader AP 105-a to accurately calculate the position of all devices (APs 105 and STAs 115) in the ad-hoc network.

In accordance with features of the present disclosure, generating the spatial map 200 allows the leader AP 105 to dynamically adjust the load on each AP (e.g., 105-a, 105-b, and 105-c) such that the load of the STAs 115 in the network are uniformly distributed across all the APs 105. Specifically, based on the spatial map 200, the leader AP 105 is more aware of location and capabilities of the plurality of STAs and APs in the ad-hoc network that allows the leader AP 105 to make an informed decision as to which STAs should be connected to which APs in order to maximize available resources. Additional considerations by the leader AP 105-a in generating a mapping information may include ensuring that the one or more STAs 115 are connected to an AP 105 with the highest RSSI and that the one or more STAs 115 are connected to APs that are in close proximity to the one or more STAs 115. Stated differently, the leader AP 105-a generates the mapping information in order to pair STAs 115 with APs 105 that they are in the closest proximity to one another because generally closer the AP 105, the higher signal quality may be observed at the STA 115 as oppose to connecting with APs 105 that may be further away.

For example, as in FIGS. 1 and 2, the STA3 115-c may be initially connected to a serving AP 105-b. However, based on the generation of the spatial map 200, aspects of the present disclosure provide the leader AP 105-a with WLAN mobile environment information to generate mapping information that maps one or more STAs 115 to the one or more APs 105 based on the above factors (e.g., distance between the STA 115 and AP 105 and signal quality). Thus, in some examples, the WLAN mobile environment information identifies not only which STA is connected with which AP, but also characteristics about every such connection, including the distance between the STA and its associated AP, and the quality of signal of that connection.

In the illustrated example of FIG. 2, although STA3 115-c may be connected to the serving AP 105-b, the leader AP 105-a, based on WLAN mobile environment information received from the one or more APs 105 and STAs 115, may determine that a target AP 105-c may serve as a better AP 105 for the STA3 115-c than the serving AP 105-b based on the comparison of the relative first distance 210 between STA3 115-c and the serving AP 105-b with the relative second distance 215 between the STA 115-c and the target AP 105-c. Due to the closer proximity between the STA3 115-c and the target AP 105-c, the leader AP 105-a may determine that the signal quality of the channel between the STA3 115-c and the AP 105 may be noticeably improved if the STA3 115-c was to transition its communication to the target AP 105-c. Accordingly, the leader AP 105-a may transmit the AP-client mapping information to the STA3 115-c via the Bluetooth interface identifying the one or more target APs 105 for STA3's 115-c consideration. The decision as to whether or not the STA3 115-c actually transitions its connection from the serving AP 105-b to the target AP 105-c, however, may depend on the STA3 115-c itself. In some examples, while the target AP 105-c may be closer and provide higher signal quality, the STA3 115-c may decide against transitioning the WLAN connectivity from the serving AP 105-b to the target AP 105-c because the target AP 105-c may be password restricted such that the STA3 115-c would be unable to establish WLAN communication with the target AP 105-c.

Thus, in accordance with features of the present disclosures, all devices (e.g., APs 105 and STAs 115) in the vicinity of the leader AP 105-a may transmit mobile environment information to the leader AP 105-a over the Bluetooth interface. For example, the serving AP 105-b (or “first AP 105-b”) and the target AP 105-c (or “second AP 105-c) may each transmit to the leader AP 105-a information regarding which STAs 115 are connected to which AP, position of the APs 105 in the mesh network, distance of other APs near (e.g., distance 230 between first AP 105-b and the second AP 105-c), distances between the APs 105 and the leader AP 105-a (e.g., first distance 225 between the first AP 105-b and the leader AP 105-a, and second distance 220 between the second AP 105-c and the leader AP 105-a), and the capabilities of each AP (e.g., first AP 105-b and second AP 105-c). In the illustrated example, the serving AP 105-b (or “first AP 105-b) may identify the STA3 115-c as the STA that is currently connected with the serving AP 105-b, along with the above-identified distances between the serving AP 105-a and the target AP 105-c, distance between the serving AP 105-b and the STA3 115-c (calculated based on RTT of signals transmitted between the AP 105 and STA 115), etc.

Similarly, the one or more STAs 115 (e.g., STA3 115-c) may also send mobile environment information, including distances such as distance of the STA 115 from the leader AP 105 (e.g., distance 205 between STA3 115-c and the leader AP 105-a), distance from the serving AP 105 (e.g., distance 210 between STA3 115-c and serving AP 105-b), distance between the STA 115 and other APs in the network (e.g., distance 215 between STA3 115-c and target AP 105-c), signal quality (e.g., RSSI) between the STA 115 and the serving AP 105-b, and/or the capabilities of the STA 115 (e.g., MU-MIMO support, transmit beam forming support, etc.).

Using the collected information regarding the WLAN mobile environment, the leader AP 105-a may determine the information of the spatial map 200 that provides insight into the physical location of each device (e.g., AP 105 and STA 115) in the network with respect to each other. Such information may be helpful in identifying the optimal/ideal AP-Client mapping that achieves load balancing across the plurality of APs 105. It should be appreciated that the terms “optimal” and “ideal” may be used interchangeably throughout the Specification. In some examples, the above process is repeated periodically so that the network may dynamically adapt to changes in the network (e.g., STA 115 mobility or one or more APs 105 going offline) in order to adjust the mapping information.

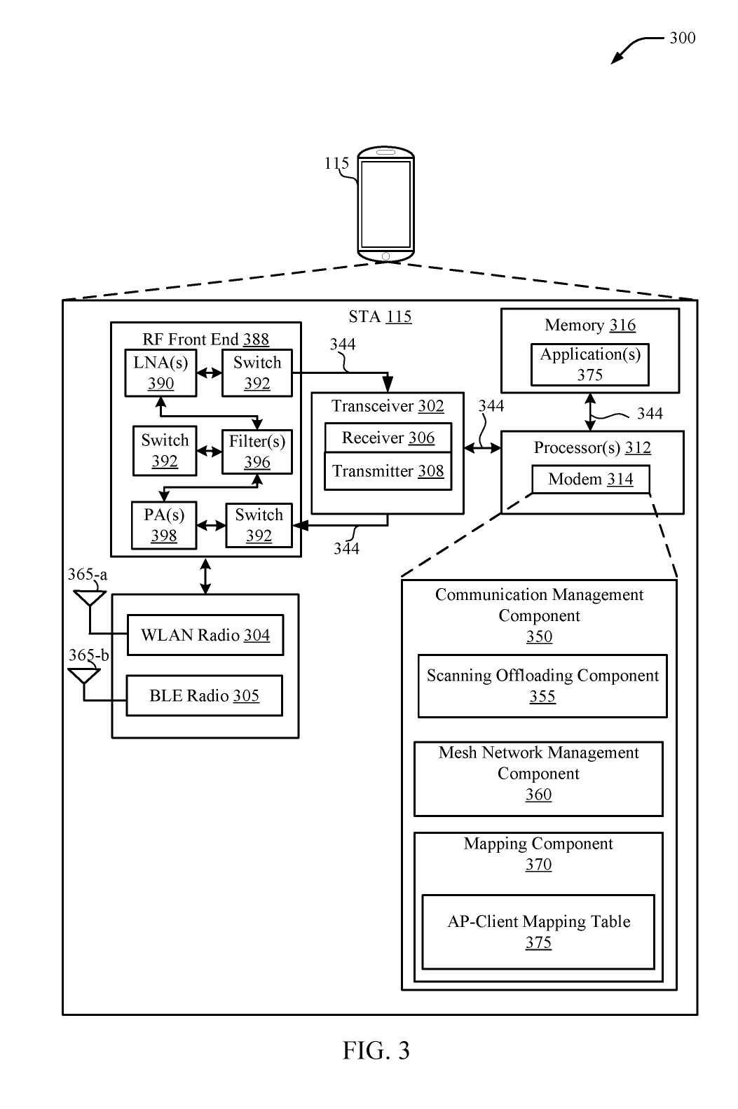

FIG. 3 describes hardware components and subcomponents of the STA 115 for implementing one or more methods (e.g., method 400) described herein in accordance with various aspects of the present disclosure. For example, one example of an implementation of STA 115 may include a variety of components, some of which have already been described above, but including components such as one or more processors 312 and memory 316 and transceiver 302 in communication via one or more buses 344, which may operate in conjunction with communication management component 350 to enable one or more of the functions described herein related to including one or more methods of the present disclosure. Further, the one or more processors 312, modem 314, memory 316, transceiver 302, RF front end 388 and one or more antennas 365, may be configured to support voice and/or data calls (simultaneously or non-simultaneously) in one or more radio access technologies. In some examples, the STA 115 may include both the WLAN radio 304 and BLE radio 305 to allow the STA 115 to establish WLAN communication (e.g., with other STAs or AP) using the WLAN radio 304 and concurrently utilize the BLE radio 305 to perform scanning operations to identify information regarding the WLAN mobile environment.

In an aspect, the one or more processors 312 can include a modem 314 that uses one or more modem processors. The various functions related to communication management component 350 may be included in modem 314 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 314 associated with communication management component 350 may be performed by transceiver 302.

Also, memory 316 may be configured to store data used herein and/or local versions of applications or communication management component 350 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining communication management component 350 and/or one or more of its subcomponents, and/or data associated therewith, when STA 115 is operating at least one processor 312 to execute communication management component 350 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 308 may be, for example, a radio frequency (RF) receiver. In an aspect, receiver 306 may receive signals transmitted by at least one AP 105. Additionally, receiver 606 may process such received signals, and also may obtain measurements of the signals, such as, but not limited to, Ec/Io, SNR, RSRP, RSSI, etc. Transmitter 308 may include hardware, firmware, and/or software code executable by a processor for transmitting data, the code comprising instructions and being stored in a memory (e.g., computer-readable medium). A suitable example of transmitter 302 may including, but is not limited to, an RF transmitter.

Moreover, in an aspect, STA 115 may include RF front end 388, which may operate in communication with one or more antennas 365 and transceiver 302 for receiving and transmitting radio transmissions, for example, wireless communications transmitted by at least one AP 105 or wireless transmissions transmitted by STA 115. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 30 and/or processor 312.

As such, transceiver 302 may be configured to transmit and receive wireless signals through one or more antennas 365 via RF front end 388. In an aspect, transceiver may be tuned to operate at specified frequencies such that STA 115 can communicate with, for example, one or more AP 105 or one or more cells associated with one or more AP 105. In an aspect, for example, modem 314 can configure transceiver 302 to operate at a specified frequency and power level based on the UE configuration of the STA 115 and the communication protocol used by modem 314.

In an aspect, modem 314 can be a multiband-multimode modem, which can process digital data and communicate with transceiver 302 such that the digital data is sent and received using transceiver 302. In an aspect, modem 314 can be multiband and be configured to support multiple frequency bands for a specific communications protocol. In an aspect, modem 314 can be multimode and be configured to support multiple operating networks and communications protocols. In an aspect, modem 314 can control one or more components of STA 115 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with STA 115 as provided by the network during cell selection and/or cell reselection.

The communication management component 350 may include a scanning offloading component 355 for offloading the scanning process to identify information regarding a WLAN mobile environment form a WLAN radio 304 to the Bluetooth radio (e.g., BLE radio 305). The communication management component 350 may further include a mesh network manager component 360 for establishing an ad-hoc network (e.g., mesh network) using Bluetooth interface between a plurality of STAs 115 and APs 105 in the network. The communication management component 350 may additionally include a mapping component 370 for receiving, from the leader AP, a mapping information that maps the STA to the one or more APs in the network. In some examples, the mapping information may include an AP-Client mapping table 375 (received from the leader AP) that provides guidance to STA 115 as to which AP 105 the STA 115 should establish communication with for improved signal quality and overall network load balancing across plurality of APs.

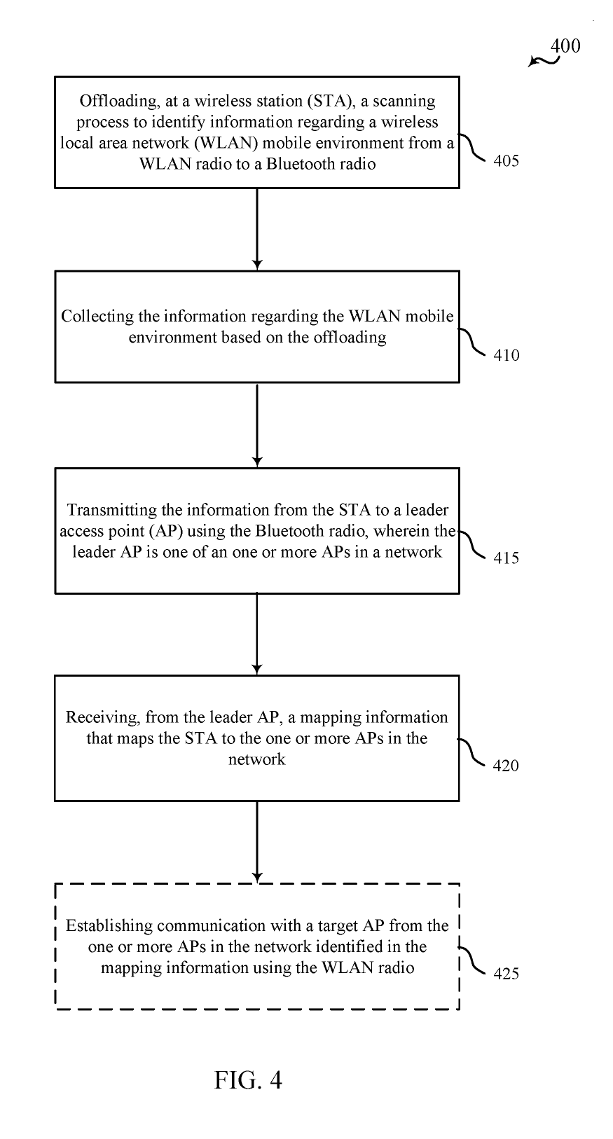

FIG. 4 is a flowchart conceptually illustrating one example of a method 400 of wireless communication, in accordance with aspects of the present disclosure. For clarity, the method 400 is described below with reference to STA 115 FIG. 1.

At block 405, the method 400 may include offloading, at a wireless STA, a scanning process to identify information regarding a WLAN mobile environment from a WLAN radio to a Bluetooth radio. In some examples, the scanning process by the BLE radio may be performed at a reduced periodicity (e.g., once every 30 seconds instead of the traditional once per second frequency) in order to reduce the scan power that may be required to perform the scans. Aspects of block 405 may be performed by scanning offloading component 355 described with reference to FIG. 3. In an aspect, the processor(s) 312 and/or the modem 314 may perform block 405 by implementing the functionality of scanning offloading component 355.

At block 410, the method 400 may include collecting the information regarding the WLAN mobile environment based on the offloading. Aspects of block 410 may also be performed by scanning offloading component 355 described with reference to FIG. 3. In an aspect, the processor(s) 312 and/or the modem 314 may perform block 410 by implementing the functionality of the scanning offloading component 355.

At block 415, the method 400 may include transmitting the information from the STA to a leader AP using the Bluetooth radio. The leader AP may be one of one or more APs in a network. In some examples, the network may be an ad-hoc network (e.g., mesh network) between the STA and the one or more APs established using the Bluetooth radio 305. In some examples, the information transmitted from the STA to the leader AP may include one or more of a relative distance between the STA and the leader AP, relative distance between the STA and a serving AP, or a signal quality of a channel between the STA and the serving AP. Aspects of block 415 may be performed by the transceiver 302 in collaboration with the BLE radio 305 described with reference to FIG. 3. In an aspect, the processor(s) 312 and/or the modem 314 may perform block 415 by implementing the functionality of transceiver 302 and/or BLE radio 305.

At block 420, the method 400 may include receiving, from the leader AP, a mapping information that maps the STA to the one or more APs in the network. In some examples, the mapping information may be generated based on spatial map of the STA and the one or more APs in the ad-hoc network using the information regarding the WLAN mobile environment transmitted by the STA 115 to the leader AP. In some examples, the spatial map may identify relative position and orientation of the STA with respect to the one or more APs in the ad-hoc network. In some aspects, the mapping information may be generated for achieving load balancing across the plurality of APs in the network, and the STA 115 may select a target AP from the one or more APs based on receiving the mapping information. Aspects of block 420 may be performed by mapping component 370. In an aspect, the processor(s) 312 and/or the modem 314 may perform block 420 by implementing the functionality of mapping component 370.

At block 425, the method 400 may optionally include establishing communication with a target AP from the one or more APs in the network identified in the mapping information using the WLAN radio. Aspects of block 425 may be performed by WLAN radio 304 in conjunction with transceiver 302 described with reference to FIG. 3.

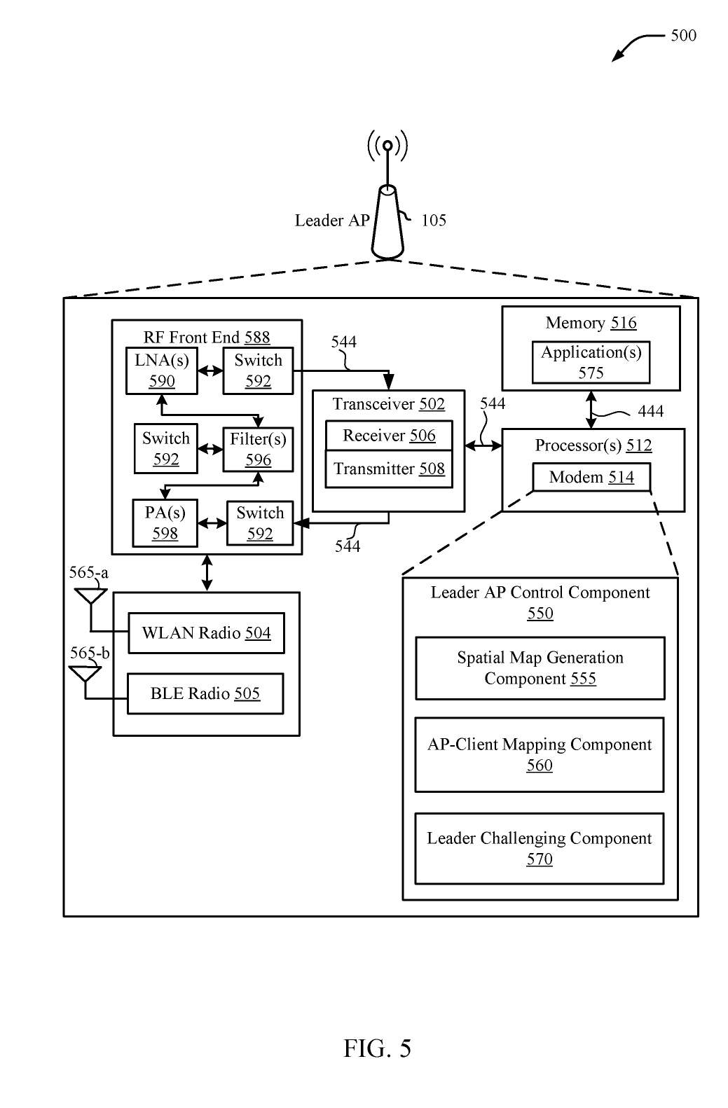

FIG. 5 describes hardware components and subcomponents of the AP 105 for implementing one or more methods (e.g., method 600) described herein in accordance with various aspects of the present disclosure. In some examples, the AP 105 may be a leader AP 105 selected from a plurality of APs 105 in the network. One example of an implementation of AP 105 may include a variety of components, some of which have already been described above, but including components such as one or more processors 512 and memory 516 and transceiver 502 in communication via one or more buses 544, which may operate in conjunction with leader AP control component 550 to enable one or more of the functions described herein related to including one or more methods of the present disclosure. Further, the one or more processors 512, modem 514, memory 516, transceiver 502, RF front end 588 and one or more antennas 565, may be configured to support voice and/or data calls (simultaneously or non-simultaneously) in one or more radio access technologies. In some examples, the AP 105 may include both the WLAN radio 504 and BLE radio 505 to allow the AP 105 to establish WLAN communication (e.g., with other STAs) using the WLAN radio 504 and concurrently utilize the BLE radio 505 to perform scanning operations to identify information regarding the WLAN mobile environment or to receive WLAN information from other APs 105 and one or more STAs.

In an aspect, the one or more processors 512 can include a modem 514 that uses one or more modem processors. The various functions related to leader AP control component 550 may be included in modem 514 and/or processors 512 and, in an aspect, can be executed by a single processor, while in other aspects, different ones of the functions may be executed by a combination of two or more different processors. For example, in an aspect, the one or more processors 512 may include any one or any combination of a modem processor, or a baseband processor, or a digital signal processor, or a transmit processor, or a receiver processor, or a transceiver processor associated with transceiver 502. In other aspects, some of the features of the one or more processors 512 and/or modem 514 associated with leader AP control component 550 may be performed by transceiver 502.

Also, memory 516 may be configured to store data used herein and/or local versions of applications or leader AP control component 550 and/or one or more of its subcomponents being executed by at least one processor 512. Memory 516 can include any type of computer-readable medium usable by a computer or at least one processor 512, such as random access memory (RAM), read only memory (ROM), tapes, magnetic discs, optical discs, volatile memory, non-volatile memory, and any combination thereof. In an aspect, for example, memory 516 may be a non-transitory computer-readable storage medium that stores one or more computer-executable codes defining a leader AP control component 550 and/or one or more of its subcomponents, and/or data associated therewith, when AP 105 is operating at least one processor 512 to execute leader AP control component 550 and/or one or more of its subcomponents.

Transceiver 502 may include at least one receiver 506 and at least one transmitter 508. Receiver 506 may include hardware, firmware, and/or software code executable by a processor for receiving data, the code comprising instructions and being stored in a memory (e.g., computer-readable medium). Receiver 508 may be, for example, a radio frequency (RF) receiver. In an aspect, receiver 506 may receive signals transmitted by at least one AP 105 or STA 115. Additionally, receiver 506 may process such received signals, and also may obtain measurements of the signals, such as, but not limited to, Ec/Io, SNR, RSRP, RSSI, etc. Transmitter 508 may include hardware, firmware, and/or software code executable by a processor for transmitting data, the code comprising instructions and being stored in a memory (e.g., computer-readable medium). A suitable example of transmitter 502 may including, but is not limited to, an RF transmitter.

Moreover, in an aspect, AP 105 may include RF front end 588, which may operate in communication with one or more antennas 565 and transceiver 502 for receiving and transmitting radio transmissions, for example, wireless communications transmitted by at least one AP 105 or wireless transmissions transmitted by STA 115. RF front end 588 may be connected to one or more antennas 565 and can include one or more low-noise amplifiers (LNAs) 590, one or more switches 592, one or more power amplifiers (PAs) 598, and one or more filters 596 for transmitting and receiving RF signals.

In an aspect, LNA 590 can amplify a received signal at a desired output level. In an aspect, each LNA 590 may have a specified minimum and maximum gain values. In an aspect, RF front end 588 may use one or more switches 592 to select a particular LNA 590 and its specified gain value based on a desired gain value for a particular application.

Further, for example, one or more PA(s) 598 may be used by RF front end 588 to amplify a signal for an RF output at a desired output power level. In an aspect, each PA 598 may have specified minimum and maximum gain values. In an aspect, RF front end 588 may use one or more switches 592 to select a particular PA 598 and its specified gain value based on a desired gain value for a particular application.

Also, for example, one or more filters 596 can be used by RF front end 588 to filter a received signal to obtain an input RF signal. Similarly, in an aspect, for example, a respective filter 596 can be used to filter an output from a respective PA 598 to produce an output signal for transmission. In an aspect, each filter 596 can be connected to a specific LNA 590 and/or PA 598. In an aspect, RF front end 588 can use one or more switches 592 to select a transmit or receive path using a specified filter 596, LNA 590, and/or PA 598, based on a configuration as specified by transceiver 502 and/or processor 512.

As such, transceiver 502 may be configured to transmit and receive wireless signals through one or more antennas 565 via RF front end 588. In an aspect, transceiver may be tuned to operate at specified frequencies such that AP 105 can communicate with, for example, one or more AP 105 or one or more STAs 115. In an aspect, for example, modem 514 can configure transceiver 502 to operate at a specified frequency and power level based on the configuration of the AP 105 and the communication protocol used by modem 514.

In an aspect, modem 514 can be a multiband-multimode modem, which can process digital data and communicate with transceiver 502 such that the digital data is sent and received using transceiver 502. In an aspect, modem 514 can be multiband and be configured to support multiple frequency bands for a specific communications protocol. In an aspect, modem 514 can be multimode and be configured to support multiple operating networks and communications protocols. In an aspect, modem 514 can control one or more components of AP 105 (e.g., RF front end 588, transceiver 502) to enable transmission and/or reception of signals from the network based on a specified modem configuration. In an aspect, the modem configuration can be based on the mode of the modem and the frequency band in use. In another aspect, the modem configuration can be based on configuration information associated with AP 105 as provided by the network during cell selection and/or cell reselection.

The leader AP control component 550 may be configured to process the received information regarding WLAN mobile environment from one or more STAs and/or one or more APs in a network over Bluetooth interface. The leader AP 105 may be one of one or more APs in the network. The leader AP control component 550 may include a spatial map generation component 555 for generating a spatial map of all the devices in the network. The spatial map identifies relative position and orientation of each of the one or more STAs and APs in the network with respect to each other such that the leader AP 105-a may create an AP-Client mapping information (e.g., AP-Client mapping table) that maps the one or more STAs to one or more target APs. In some examples, although the decision whether to transition from the serving AP to the target AP rests with the STA 115 itself, the leader AP control component 55 may take necessary actions (e.g., channel switch announcements) to organize the perfect match layer (PML) information. The one or more clients (e.g., STAs) may use the PML in conjunction to the RSSI and other information to make better roaming decisions and connect to the optimal AP.

Additionally or alternatively, the leader AP control component 550 may continuously update the spatial map information in order to dynamically adapt to changes in the network (e.g., STA 115 mobility or one or more APs 105 going offline) in order to adjust the mapping information. The leader AP may also be responsible for identifying client information radiation points (CIRP) in the mesh network. The CIRP may be members of the mesh network which are selected by the leader AP to periodically advertise optimal AP-Client relations and channels to use as BLE advertisements to the one or more STAs. The leader AP control component 550 may select and assign one or more devices the role of a CIRP such that information from the CIRP devices may periodically transmit BLE advertisements that may help steer the one or more STAs to the ideal AP (e.g., based on the closest proximity or higher signal quality) in order to optimize the network load across the plurality of APs. In some examples, only other APs may be selected as CIRP in the mesh network.

The leader AP control component 550 may further include a leader challenging component 570 to challenge another AP's 105 attempt to create a new mesh network when an existing network supported by the leader AP is already established. Such challenges ensure that only one leader AP is selected in the vicinity, and thus limits formation of multiple mesh networks within closer proximity. However, if the heartbeat (e.g., pulse or beacons) of the leader are lost for a period of time, each of the active APs may transmit BLE advertisements that include time values identifying the length of time that each AP has been on the network. In some examples, the oldest AP (e.g., based on length of time that the AP has been active on the network) may be selected as a new leader AP to replace the existing leader AP. The new leader AP will then advertise to the other devices on the network that it has assumed the role of a leader AP. However, if during such advertisement, another AP challenges the leader AP status, the challenging AP may need to establish that it has been active on the network for longer duration than the newly selected leader AP.

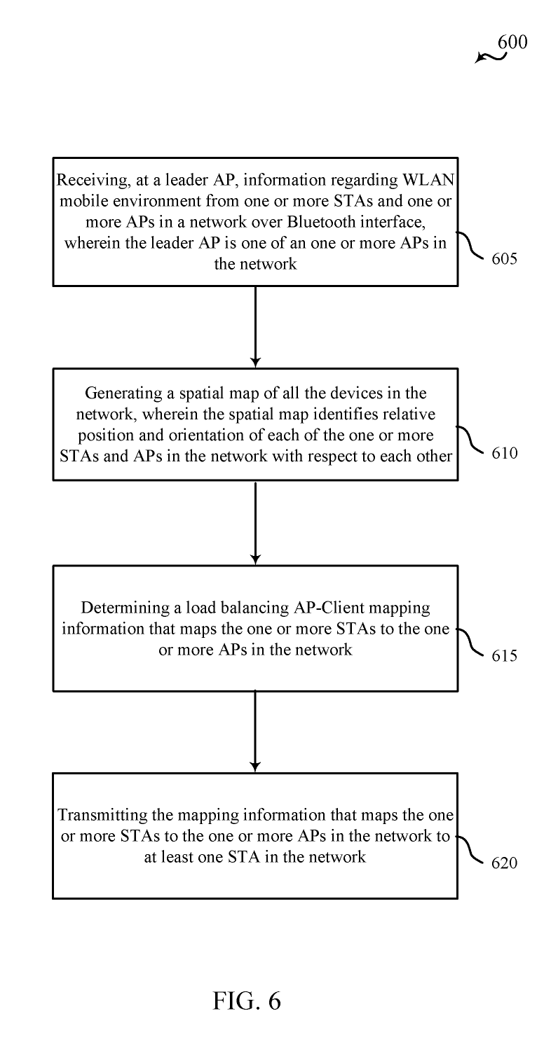

FIG. 6 is a flowchart conceptually illustrating another example of a method 600 of wireless communication, in accordance with aspects of the present disclosure. For clarity, the method 600 is described below with reference to AP 105 of FIG. 1.

At block 605, the method 600 may include receiving, at a leader AP, information regarding WLAN mobile environment from one or more STAs and one or more APs in a network over Bluetooth interface. The leader AP may be one of one or more APs in the network. In some examples, the information regarding the WLAN mobile environment may be received after a creation of an ad-hoc network by the leader AP advertising mesh network ID of the newly formed ad-hoc network. In some examples, the ad-hoc network may be supported over the Bluetooth interface by the BLE radios of the one or more devices in the network.

The information received over the BLE radio from the one or more STAs may include STA MAC address, the SSID/MAC address of the AP that the STA is connected to, the WLAN channels and features supported by the STA, RTT based distance from the leader, RTT based distance from the AP that it is connected to, location of the serving AP, and if available, the angle from the leader AP and the serving AP. In some examples, the angle may be determined using Bluetooth angle-of-arrival (AoA)/angle-of-departure (AoD).

Similarly, the information received over the BLE radio from the one or more APs in the network may include the AP SSID and MAC address of each AP, the WLAN channels and features supported by each AP, RTT distance between the AP and one or more additional APs in the network, RTT based distance between the AP and the leader AP, physical location of the AP, and the angle of the AP from the leader AP and other APs determined based on Bluetooth AoA/AoD. Aspects of block 605 may be performed by receiver 506 in collaboration with BLE radio 505 described with reference to FIG. 5. In an aspect, the processor(s) 512 and/or the modem 514 may perform block 605 by implementing the functionality of receiver 506 and/or BLE radio 505.

At block 610, the method 600 may include generating a spatial map of all the devices in the network. The spatial map identifies relative position and orientation of each of the one or more STAs and APs in the network with respect to each other. In some examples, the leader AP may use the aggregate information received from the one or more STAs and APs in the network over BLE radio to create a spatial map that identifies how the one or more APs are distributed in the environment with respect to each other and the load on each AP (e.g., based on number of STAs being supported by each AP). Aspects of block 610 may be performed by spatial map generation component 555 described with reference to FIG. 5. In an aspect, the processor(s) 512 and/or the modem 514 may perform block 605 by implementing the functionality of receiver 506 and/or BLE radio 505.

At block 615, the method 600 may include determining a load balancing AP-Client mapping information that maps the one or more STAs to the one or more APs in the network. In some examples, the leader AP 105 based on the collected information determines the load balancing AP-Client mapping information by selecting CIRPs such that the CIRPs (APs) are uniformly distributed in the network. The leader AP 105 in conjunction with CIRPs may decide how to distribute the one or more STAs with other APs and the channels each STA may use to maximize load balancing and minimizing interruptions between multiple APs operating in close proximity to one another (e.g., by distributing the channels each STA and AP utilize). Aspects of block 615 may be performed by AP-Client mapping component 560 described with reference to FIG. 5. In an aspect, the processor(s) 512 and/or the modem 514 may perform block 615 by implementing the functionality of AP-Client mapping component 560.

At block 620, the method 600 may include transmitting the mapping information that maps the one or more STAs to the one or more APs in the network to at least one STA in the network. Aspects of block 620 may be performed by the transceiver 502 in collaboration with the BLE radio 505 described with reference to FIG. 5. In an aspect, the processor(s) 512 and/or the modem 514 may perform block 620 by implementing the functionality of transceiver 502 and BLE radio 505.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method for wireless communication, comprising:
offloading, at a wireless station (STA), a scanning process to identify information regarding a wireless local area network (WLAN) mobile environment from a WLAN radio to a Bluetooth radio;
collecting the information regarding the WLAN mobile environment based on the offloading;
transmitting the information from the STA to a leader access point (AP) using the Bluetooth radio, wherein the leader AP is one of one or more APs in a network; and
receiving, from the leader AP, a mapping information that maps the STA to the one or more APs in the network.

2. The method of claim 1, further comprising:
establishing communication with a target AP from the one or more APs in the network identified in the mapping information using the WLAN radio.

3. The method of claim 1, wherein the network is an ad-hoc network between the STA and the one or more APs established using the Bluetooth radio.

4. The method of claim 3, wherein the leader AP generates a spatial map of the STA and the one or more APs in the ad-hoc network using the information transmitted by the STA, and wherein the spatial map identifies relative position and orientation of the STA with respect to the one or more APs in the ad-hoc network.

5. The method of claim 3, wherein the mapping information is generated for achieving load balancing for the ad-hoc network, and
the STA selects a target AP from the one or more APs based on receiving the mapping information.

6. The method of claim 1, wherein the information transmitted from the STA to the leader AP includes one or more of:
a relative distance between the STA and the leader AP;
a relative distance between the STA and a serving AP; or
a signal quality of a channel between the STA and the serving AP.

7. The method of claim 1, wherein the Bluetooth radio is a Bluetooth Low Energy radio.

8. An apparatus for wireless communication, comprising:
a processor;
a memory coupled to the processor, wherein the memory includes instructions executable by the processor to:
offload, at a wireless station (STA), a scanning process to identify information regarding a wireless local area network (WLAN) mobile environment from a WLAN radio to a Bluetooth radio;
collect the information regarding the WLAN mobile environment based on the offloading;
transmit the information from the STA to a leader access point (AP) using the Bluetooth radio, wherein the leader AP is one of one or more APs in a network; and
receive, from the leader AP, a mapping information that maps the STA to the one or more APs in the network.

9. The apparatus of claim 8, wherein the instructions are further executable by the processor to:
establish communication with a target AP from the one or more APs in the network identified in the mapping information using the WLAN radio.

10. The apparatus of claim 8, wherein the network is an ad-hoc network between the STA and the one or more APs established using the Bluetooth radio.

11. The apparatus of claim 10, wherein the leader AP generates a spatial map of the STA and the one or more APs in the ad-hoc network using the information transmitted by the STA, and wherein the spatial map identifies relative position and orientation of the STA with respect to the one or more APs in the ad-hoc network.

12. The apparatus of claim 10, wherein the mapping information is generated for achieving load balancing for the ad-hoc network, and
the STA selects a target AP from the one or more APs based on receiving the mapping information.

13. The apparatus of claim 8, wherein the information transmitted from the STA to the leader AP includes one or more of:
a relative distance between the STA and the leader AP;
a relative distance between the STA and a serving AP; or
a signal quality of a channel between the STA and the serving AP.

14. The apparatus of claim 8, wherein the Bluetooth radio is a Bluetooth Low Energy radio.

15. A computer-readable medium storing computer executable code for wireless communications, comprising code to:
offload, at a wireless station (STA), a scanning process to identify information regarding a wireless local area network (WLAN) mobile environment from a WLAN radio to a Bluetooth radio;
collect the information regarding the WLAN mobile environment based on the offloading;
transmit the information from the STA to a leader access point (AP) using the Bluetooth radio, wherein the leader AP is one of one or more APs in a network; and
receive, from the leader AP, a mapping information that maps the STA to the one or more APs in the network.

16. The computer-readable medium of claim 15, wherein the computer executable code further includes code to:
establish communication with a target AP from the one or more APs in the network identified in the mapping information using the WLAN radio.

17. The computer-readable medium of claim 15, wherein the network is an ad-hoc network between the STA and the one or more APs established using the Bluetooth radio.

18. The computer-readable medium of claim 17, wherein the leader AP generates a spatial map of the STA and the one or more APs in the ad-hoc network using the information transmitted by the STA, and wherein the spatial map identifies relative position and orientation of the STA with respect to the one or more APs in the ad-hoc network.

19. The computer-readable medium of claim 17, wherein the mapping information is generated for achieving load balancing for the ad-hoc network, and
the STA selects a target AP from the one or more APs based on receiving the mapping information.

20. The computer-readable medium of claim 15, wherein the information transmitted from the STA to the leader AP includes one or more of:
a relative distance between the STA and the leader AP;
a relative distance between the STA and a serving AP; or
a signal quality of a channel between the STA and the serving AP.
